(19) United States
(12) Patent Application Publication
(10) Pub. No.: US 2014/0160171 A1
(43) Pub. Date: Jun. 12, 2014

(54) DRIVE SYSTEM FOR LIQUID CRYSTAL DISPLAY DEVICE

(71) Applicant: Shenzhen China Star Optoelectronics Technology Co., Ltd., Shenzhen, Guangdong (CN)

(72) Inventor: Xueliang Yang, Shenzhen City (CN)

(73) Assignee: Shenzhen China Star Optoelectronics Technology Co., Ltd., Shenzhen, Guangdong (CN)

(21) Appl. No.: 13/807,078

(22) PCT Filed: Dec. 11, 2012
(86) PCT No.: PCT/CN2012/086321

§ 371 Date: Dec. 27, 2012

(30) Foreign Application Priority Data
Dec. 6, 2012 (CN) 201210519517.2

(51) Int. Cl. G09G 3/36

(52) U.S. Cl. CPC G09G 3/3607
USPC 345/690

(57) ABSTRACT

The present invention provides a drive system for liquid crystal display device, which includes timing controller, providing timing control signal; source driver, connected to a plurality of data lines S₁ to Sₙ of LCD to drive data lines S₁ to Sₙ according to timing control signal provided by timing controller; gate driver, connected to a plurality of gate lines G₁ to Gₘ of LCD to drive gate lines G₁ to Gₘ according to timing control signal provided by timing controller, m and n being integers greater than 1; wherein timing controller storing data for generating pixel grayscale reference voltage, source driver including pixel grayscale reference voltage generation unit, pixel grayscale reference voltage generation unit receiving data for generating pixel grayscale reference voltage from timing controller to generate pixel grayscale reference voltage. As such, the present invention eliminates P-Gamma calibration circuit, simplifies LCD design and reduces cost.

### BACKGROUND OF THE INVENTION

1. Field of the Invention

The present invention relates to the field of liquid crystal displaying techniques, and in particular to a drive system for liquid crystal display device.

2. The Related Arts

A drive system for liquid crystal display device (LCD) usually comprises timing controller, programmable Gamma (P-Gamma) calibration circuit, source driver, gate driver, voltage converter, and so on. Because the LCD drive system comprises many components, the design is usually complex and costs more.

### SUMMARY OF THE INVENTION

The present invention provides a drive system for liquid crystal display device, which comprises: a timing controller, providing timing control signal; a source driver, connected to a plurality of data lines S₁ to Sₙ of the LCD to drive the plurality of data lines S₁ to Sₙ according to the timing control signal provided by the timing controller, n being an integer greater than 1; a gate driver, connected to a plurality of gate lines G₁ to Gₘ of the LCD to drive the plurality of gate lines G₁ to Gₘ according to the timing control signal provided by the timing controller, m being an integer greater than 1; wherein the timing controller storing data for generating pixel grayscale reference voltage, the source driver comprising pixel grayscale reference voltage generation unit, the pixel grayscale reference voltage generation unit receiving data for generating pixel grayscale reference voltage from the timing controller to generate pixel grayscale reference voltage; wherein the pixel grayscale reference voltage generation unit comprising: a plurality of resistance dividers, connected in series between the operating voltage of the source driver and the ground; a selection unit, based on the voltage level of the data for generating pixel grayscale reference voltage from the timing controller, selecting one of the node voltages of the adjacent resistance dividers of the plurality of resistance dividers; and an amplifier, for amplifying the selected node voltage selected by the selection unit as the pixel grayscale reference voltage.

According to a preferred embodiment of the present invention, the drive system for LCD further comprises: a voltage converter, for receiving a predetermined reference voltage, converting the predetermined reference voltage into operating voltage required by the timing controller, source driver and gate driver, and providing corresponding operating voltage to the timing controller, source driver and gate driver.

According to a preferred embodiment of the present invention, the source driver further comprises: a verification unit, for verifying whether the signal from the timing controller being timing control signal for the source driver, or the data for generating pixel grayscale reference voltage.

According to a preferred embodiment of the present invention, if the verification unit verifies that the signal from the timing controller is data for generating pixel grayscale reference voltage, the verification unit will provides the data for generating pixel grayscale reference voltage to the selection unit of the pixel grayscale reference voltage generation unit.

According to a preferred embodiment of the present invention, the LCD panel comprises a plurality of pixel units, the number of pixel units is m×n, each pixel unit Pᵢⱼ is disposed at the node between i-th gate line and the j-th data line, wherein I and j are both integers and 1≦i≦m, 1≦j≦n.

According to a preferred embodiment of the present invention, the pixel unit Pᵢⱼ comprises: a thin film transistor, a liquid crystal capacitor and a storage capacitor; wherein the gate terminal of the thin film transistor is connected to the i-th gate line, the source terminal of the thin film transistor is connected to the j-th source line, one end of the liquid crystal capacitor and the storage capacitor is connected to the drain terminal of the thin film transistor, and the other end of the liquid crystal capacitor and the storage capacitor is grounded.

According to a preferred embodiment of the present invention, based on the timing control signal from the timing controller, the gate driver and the source driver can make the thin film transistors of each column to conduct or cut-off according to the column order to store the data of pixel units of each column.

According to a preferred embodiment of the present invention, when the voltage level of the gate line is high, the thin film transistors of the pixel units of the corresponding column can be conductive so that the source driver performs charging on the pixel units of the column through the liquid crystal capacitor; when the voltage level of the gate line is low, the thin film transistors of the pixel units of the corresponding column can be cut-off so that the data of the pixel units of the column can be stored through the storage capacitor.

The present invention eliminates the P-Gamma calibration circuit and simplifies the LCD circuit design as well as reduces the manufacturing cost.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a block diagram of the drive system for LCD according to an embodiment of the present invention;

FIG. 2 is a diagram showing connection between the LCD panel and the source driver and the gate driver according to an embodiment of the present invention;

FIG. 3 is a block diagram of the source driver according to an embodiment of the present invention; and

FIG. 4 is a block diagram of the pixel grayscale reference voltage generation unit of the source driver in the drive system according to an embodiment of the present invention.

### DETAILED DESCRIPTION OF THE PREFERRED EMBODIMENTS

The following refers to the drawings to describe the embodiment of the present invention in details.

The known LCD drive system uses P-Gamma calibration circuit as gate driver to provide pixel grayscale reference voltage. The P-Gamma calibration circuit mainly comprises storage circuit and modulus converter circuit. In the present invention, the timing controller and the source driver are improved so that the timing controller stores the data for generating pixel grayscale reference voltage and the source driver outputs pixel grayscale reference voltage so as to eliminate the P-Gamma calibration circuit, simplify the circuit design and reduce the manufacturing cost.

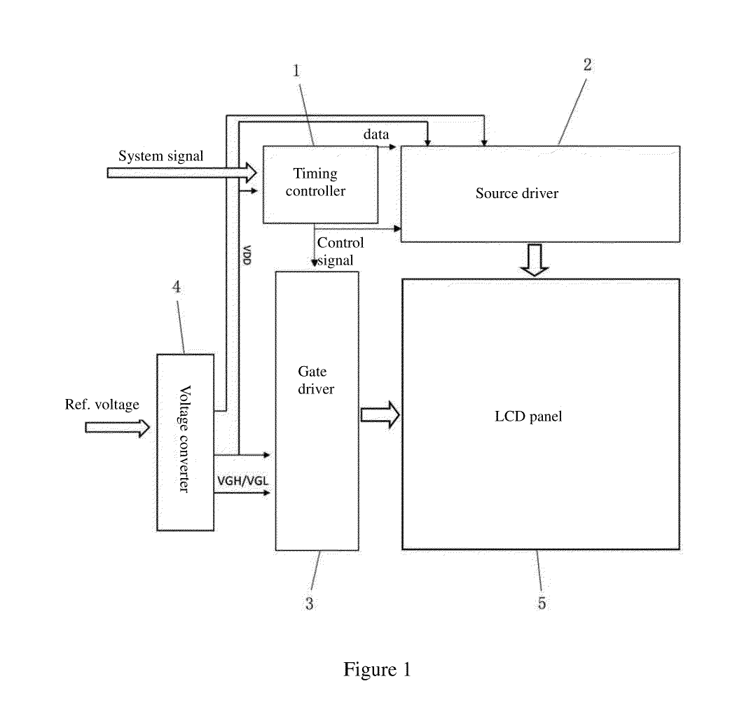

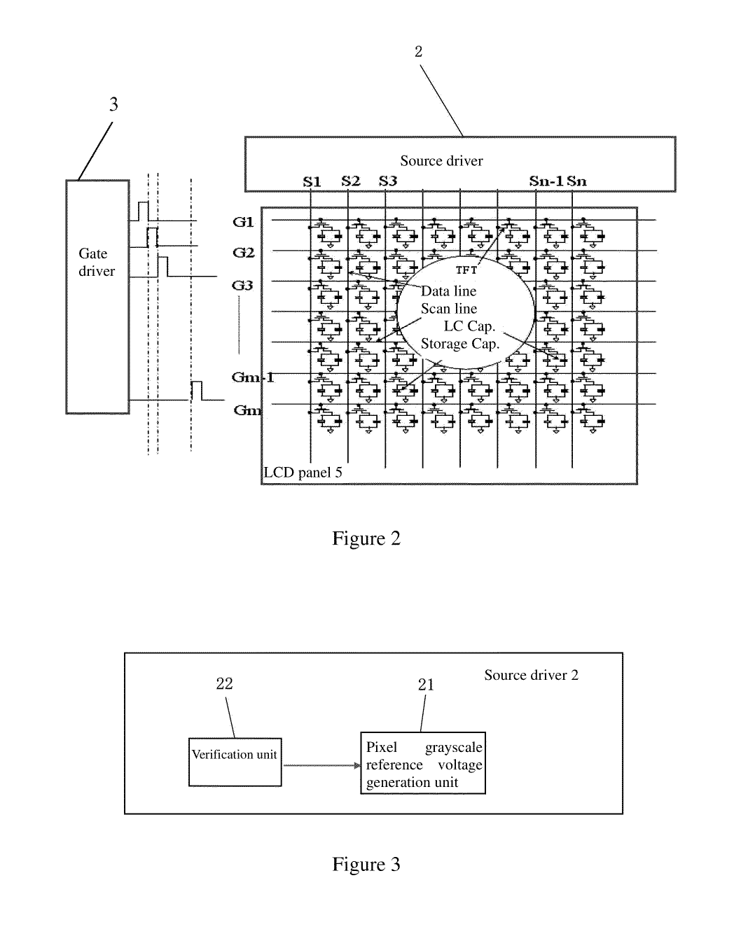

Referring to FIG. 1 and FIG. 2, the drive system for LCD comprises: a timing controller 1, a source driver 2, a gate driver 3 and a voltage converter 4.

The timing controller 1 provides timing control signals to the source driver 2 and the gate driver 3 to control the operation of the source driver 2 and the gate driver 3.

The source driver 2 is connected to a plurality of data lines S₁ to Sₙ of the LCD panel 5 to drive the plurality of data lines S₁ to Sₙ according to the timing control signal provided by the timing controller, wherein n is an integer greater than 1.

The gate driver 3 is connected to a plurality of gate lines G₁ to Gₘ of the LCD panel 5 to drive the plurality of gate lines G₁ to Gₘ according to the timing control signal provided by the timing controller, wherein m is an integer greater than 1.

The voltage converter receives a predetermined reference voltage (such as, 12V) provided by the drive system, converts the predetermined reference voltage into operating voltage required by the timing controller 1, source driver 2 and gate driver 3, and provides corresponding operating voltage to the timing controller 1, source driver 2 and gate driver 3. For example, for the timing controller 1, the voltage converter 4 converts the reference voltage into 3.3V and provides to the timing controller 1; for the source driver, the voltage converter 4 converts the reference voltage into 15.3V and provides to the source driver 2; and for the gate driver 3, the voltage converter 4 converts the reference voltage into 6V low gate voltage (VGL) and 33V high gate voltage (VGH), and provides the VGL and VGH to the gate driver 3. The voltage converter 4 can be a PWM converter.

Referring to FIG. 2, the plurality of data lines S₁ to Sₙ and the plurality of gate lines G₁ to Gₘ of the LCD panel 5 are disposed perpendicularly to each other to form an m×n matrix.

The LCD panel 5 comprises a plurality of pixel units P₁₁, . . . , P₁ₙ, . . . , Pₘₙ. The number of pixel units is m×n. Each pixel unit Pᵢⱼ is disposed at the node between i-th gate line and the j-th data line (1≦i≦m, 1≦j≦n). The pixel unit Pᵢⱼ comprises: a thin film transistor (TFT), a liquid crystal capacitor and a storage capacitor. The gate terminal of the TFT is connected to the i-th gate line, and the source terminal of the TFT is connected to the j-th source line. One end of the liquid crystal capacitor and the storage capacitor is connected to the drain terminal of the TFT, and the other end of the liquid crystal capacitor and the storage capacitor is grounded.

Based on the timing control signal from the timing controller 1, the gate driver 3 and the source driver 2 can collaborate to make the TFTs of each column to conduct or cut-off according to the column order to store the data of pixel units of each column. When the voltage level of the gate line is high, the TFTs of the pixel units of the corresponding column can be conductive so that the source driver performs charging on the pixel units of the column through the liquid crystal capacitor; when the voltage level of the gate line is low, the TFTs of the pixel units of the corresponding column can be cut-off so that the data of the pixel units of the column can be stored through the storage capacitor.

According to the present invention, the timing controller 1 can use own memory to store data for generating pixel grayscale reference voltage. The data is transmitted to the source driver 2 for generating pixel grayscale reference voltage. The data can be transmitted through, such as, Mini-LVDS protocol, to the source driver 2.

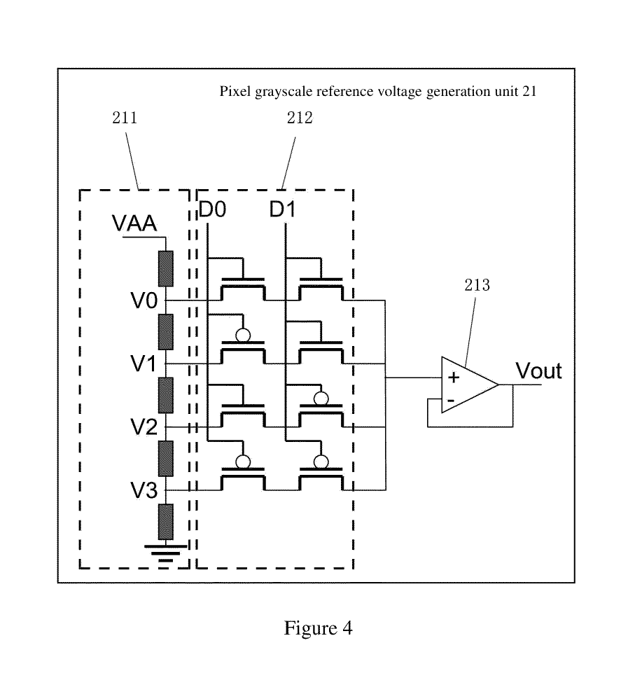

Referring to FIG. 3 and FIG. 4, the source driver 2 comprises a pixel grayscale reference voltage generation unit 21. The pixel grayscale reference voltage generation unit 21 receives the data for generating pixel grayscale reference voltage from the timing controller 1 to generate pixel grayscale reference voltage.

Referring to both FIGS. 1-2, specifically, the pixel grayscale reference voltage generation unit 21 comprises a plurality of resistance dividers 211, connected in series between the operating voltage VAA of the source driver 2 and the ground; a selection unit 212, based on the voltage level of the data for generating pixel grayscale reference voltage from the timing controller 1, selecting one of the node voltages of the adjacent resistance dividers 211 of the plurality of resistance dividers; and an amplifier 213, for amplifying the selected node voltage selected by the selection unit as the pixel grayscale reference voltage. Therefore, by changing the voltage level of the data for generating pixel grayscale reference voltage from the timing controller 1, the programmable pixel grayscale reference voltage can be generated. FIG. 4 shows the scenario of the 2-bit data (D0, D1) for generating pixel grayscale reference voltage, able to selectively outputting 2²=4 voltages. However, the present invention is not limited to this embodiment. More bits for data to generate pixel grayscale reference voltage can be included when the application demands more pixel grayscale reference voltage, and number of resistance dividers 211 can be increased accordingly. For example, when the number of data bits provided by the timing controller 1 is eight, 2⁸=64 voltages can be selectively outputted.

The following Table 1 shows the relation between the voltage level of data (D0, D1) and the outputted pixel grayscale reference voltage.

| D0 | D1 | Vout |
|---|---|---|
| 1 | 1 | V0 |
| 0 | 1 | V1 |
| 1 | 0 | V2 |
| 0 | 0 | V3 |

The source driver 2 can further comprise: a verification unit 22. Referring to FIGS. 1-2, the verification unit 22 is for verifying whether the signal from the timing controller 1 is timing control signal for the source driver 2, or the data for generating pixel grayscale reference voltage. If the verification unit 22 verifies that the signal from the timing controller 1 is data for generating pixel grayscale reference voltage, the verification unit 22 will provides the data for generating pixel grayscale reference voltage to the selection unit 212 of the pixel grayscale reference voltage generation unit 21. If the verification unit 22 verifies that the signal from the timing controller 1 is timing control signal for the source driver 2, the source driver 2 will operate according to the timing control signal.

Therefore, the present invention eliminates the P-Gamma calibration circuit, simplifies LCD circuit design and reduces manufacturing cost.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A drive system for liquid crystal display device, which comprises:
a timing controller, providing timing control signal;
a source driver, connected to a plurality of data lines S₁ to Sₙ of the LCD to drive the plurality of data lines S₁ to Sₙ according to the timing control signal provided by the timing controller, n being an integer greater than 1;
a gate driver, connected to a plurality of gate lines G₁ to Gₘ of the LCD to drive the plurality of gate lines G₁ to Gₘ according to the timing control signal provided by the timing controller, m being an integer greater than 1;
wherein the timing controller storing data for generating pixel grayscale reference voltage;
the source driver comprising pixel grayscale reference voltage generation unit, the pixel grayscale reference voltage generation unit receiving data for generating pixel grayscale reference voltage from the timing controller to generate pixel grayscale reference voltage;
wherein the pixel grayscale reference voltage generation unit comprising:
a plurality of resistance dividers, connected in series between the operating voltage of the source driver and the ground; a selection unit, based on the voltage level of the data for generating pixel grayscale reference voltage from the timing controller, selecting one of the node voltages of the adjacent resistance dividers of the plurality of resistance dividers; and an amplifier, for amplifying the selected node voltage selected by the selection unit as the pixel grayscale reference voltage.

2. The drive system for liquid crystal display device as claimed in claim 1, wherein the drive system for LCD further comprises: a voltage converter, for receiving a predetermined reference voltage, converting the predetermined reference voltage into operating voltage required by the timing controller, source driver and gate driver, and providing corresponding operating voltage to the timing controller, source driver and gate driver.

3. The drive system for liquid crystal display device as claimed in claim 1, wherein the source driver further comprises: a verification unit, for verifying whether the signal from the timing controller being timing control signal for the source driver, or the data for generating pixel grayscale reference voltage.

4. The drive system for liquid crystal display device as claimed in claim 3, wherein if the verification unit verifies that the signal from the timing controller is data for generating pixel grayscale reference voltage, the verification unit will provides the data for generating pixel grayscale reference voltage to the selection unit of the pixel grayscale reference voltage generation unit.

5. The drive system for liquid crystal display device as claimed in claim 1, wherein the LCD panel comprises a plurality of pixel units, the number of pixel units is m×n, each pixel unit Pᵢⱼ is disposed at the node between i-th gate line and the j-th data line, wherein i and j are both integers and 1≦i≦m, 1≦j≦n.

6. The drive system for liquid crystal display device as claimed in claim 5, wherein the pixel unit Pᵢⱼ comprises: a thin film transistor, a liquid crystal capacitor and a storage capacitor; wherein the gate terminal of the thin film transistor is connected to the i-th gate line, the source terminal of the thin film transistor is connected to the j-th source line, one end of the liquid crystal capacitor and the storage capacitor is connected to the drain terminal of the thin film transistor, and the other end of the liquid crystal capacitor and the storage capacitor is grounded.

7. The drive system for liquid crystal display device as claimed in claim 6, wherein based on the timing control signal from the timing controller, the gate driver and the source driver can make the thin film transistors of each column to conduct or cut-off according to the column order to store the data of pixel units of each column.

8. The drive system for liquid crystal display device as claimed in claim 7, wherein when the voltage level of the gate line is high, the thin film transistors of the pixel units of the corresponding column can be conductive so that the source driver performs charging on the pixel units of the column through the liquid crystal capacitor; when the voltage level of the gate line is low, the thin film transistors of the pixel units of the corresponding column can be cut-off so that the data of the pixel units of the column can be stored through the storage capacitor.
